(19) United States
(12) Patent Application Publication
(10) Pub. No.: US 2011/0155682 A1
(43) Pub. Date: Jun. 30, 2011

(54) LIFTING DEVICE FOR THE INSTALLATION AND SERVICE OF AN UNDERWATER POWER PLANT

(76) Inventors: Matthias Grassow, Ulm (DE); Benjamin Holstein, Heidenheim (DE); Norman Perner, Ulm (DE); Jochen Weilepp, Heidenheim (DE)

(21) Appl. No.: 12/734,688

(22) PCT Filed: Jul. 4, 2009
(86) PCT No.: PCT/EP2009/004830

§ 371 Date: Mar. 15, 2011

(30) Foreign Application Priority Data
Jul. 11, 2008 (DE) 10 2008 032 625.9

(51) Int. Cl. B66C 1/42; B66C 23/00; B65G 67/60

(52) U.S. Cl. 212/270; 294/66.1

(57) ABSTRACT

The invention relates to a lifting device for placing and/or lifting a turbine-generator unit of an underwater power plant onto or off of a support structure, comprising a submersible component having a transverse centering device and a gripping device; the transverse centering device causing lateral centering of the submersible component relative to the turbine-generator unit by a support on the support structure; and the gripping device comprising a movable clamping element for the detachable securing of the turbine-generator unit.

The invention relates to a lifting device for the installation and service of an underwater power plant having a turbine-generator unit, which can be placed on a support structure.

Submersible underwater power plants for obtaining power from an ocean current, in particular a tidal current, are known. For one possible embodiment, a turbine-generator unit which is fastened on a support structure has free flow around it without an additional dam structure. The water turbine can be implemented in the form of a rotor and can revolve on a machine nacelle, in which the generator components and the drive train are accommodated.

Large-scale underwater power plants, which have a correspondingly high plant weight, are required for exploiting small current speeds. This results in difficult plant installation and in consequent problems upon the execution of maintenance work, which is required for lifting the underwater power plant above the water level. Therefore, implementing an underwater power plant for operation in the ocean in two parts has been proposed. Firstly, a first plant part, which is used for the foundation, is lowered after a seabed preparation at the installation location with the support structure. Subsequently, the second plant part, the turbine-generator unit, is placed on the support structure and mounted using a coupling device.

Reference is made for exemplary purposes to WO 0712539 A for a two-part plant concept, from which a turbine-generator unit provided with a conically tapering coupling connecting piece is known, which is lowered to the support structure using a ship-mounted crane. As the counterpart to the conically tapering coupling connecting piece, the upper part of the support column of the support structure expands conically. Secure coupling requires, however, that this conical receptacle and the conically tapering coupling connecting piece align sufficiently with one another. This is only to be achieved with difficulty in particular in the case of great water depths under stormy weather conditions. For this reason, it is proposed by WO 2004/015207 A1 that vertically running guide cables be provided for the installation of a two-part underwater power plant having a support structure which comprises a conical receptacle. The turbine-generator unit is lowered along the guide cable. The use of a cable guide has the disadvantage, however, that firstly the guide cable must be drawn, starting from the water vehicle used for the installation, up to the support structure and fastened thereon. This installation step is typically performed by divers and is thus complex and hazardous.

It is also disadvantageous that the guide cables must be removed after the initial installation of the underwater power plant, in order to reliably prevent winding of the guide cables in the water turbine during operation. In case of retrieval of the turbine-generator unit to execute a plant inspection above water, the necessity then exists of implementing a linkage for a crane system to the turbine-generator unit and executing a vertical movement, which is laterally guided as well as possible and centered, to lift the turbine-generator unit out of the coupling device. Service divers are typically again necessary for hanging the crane hook and/or for attaching support belts and for fastening guide cables, which, in addition to the high danger of accident, makes plant service more costly.

The invention is based on the object of disclosing a lifting device, which allows a turbine-generator unit of an underwater power plant to be placed on an assigned support structure for the installation and allows the turbine-generator unit to be lifted off of the support structure and hauled onto the deck of a water vehicle for the maintenance of an already installed plant. It is desirable for both the initial installation and also the plant service to be executed using a lift device. Furthermore, a method is sought which allows secure placement of a turbine-generator unit on a support structure and subsequent lifting of this unit above the water level. The device and the method are to be distinguished by high handling safety of the turbine-generator unit and are to allow such an extensive degree of automation that the use of service divers can be largely dispensed with. Furthermore, rapid installation and retrieval of the turbine-generator unit are required, because the time window having weak current is typically small. Furthermore, the device and the method are to be distinguished by universal use for various underwater power plants having similar size dimensions, which are differently designed in detail.

The object on which the invention is based is achieved by the features of the independent claims. Advantageous embodiments of the invention are specified in the subclaims.

A lifting device according to the invention comprises a submersible component, which is lowered by a ship-mounted crane down to the installation location of the underwater power plant. The submersible component comprises a transverse centering device and a gripping device, which are connected to one another. The transverse centering device is used for the purpose of laterally orienting the submersible component in relation to the support structure by a support on the support structure and in particular by grasping a part of the support structure. A lateral orientation is understood to mean that the submersible component is brought into a specific position with respect to at least one transverse direction in relation to the vertical axis of the underwater power plant. Centering is preferably performed in two directions running perpendicular to one another transversely to the vertical axis.

Using the crane system, the submersible component which is laterally secured and centered in this manner can be brought to an immersion depth which allows the gripping device to encompass the turbine-generator unit to secure it using a movable clamping element. If at least two pliers-shaped clamping jaws, which act against one another, are used for this purpose for the clamping element, which are able to carry the entire weight of the turbine-generator unit, it can be lifted out of the coupling apparatus of the support structure using a crane system connected to the submersible component.

The movable clamping element of the gripping device particularly preferably encloses the housing of the machine nacelle of the generator-turbine unit. The weight of the turbine-generator unit is received by a form fit and/or friction lock for an advantageous design. For an alternative design, the weight is supported by a slotted support frame pushed under the generator-turbine unit, which represents a preferred further part of the submersible component. The clamping element of the gripping device fulfills the function of securing the generator-turbine unit against slipping off of the support frame.

For a first advantageous embodiment, the enclosure movement of the clamping element occurs from below. For this purpose, the submersible component is first moved laterally to the support structure for a plant service, so that the gripping device is below the machine nacelle in the open state and is guided under it in the last part of the approach movement. This final approach movement is preferably guided by the movement of a movable enclosure element of the transverse centering device. One possible design for the enclosure element is again a configuration of movable clamping jaws similar to pliers. These are used for the purpose of enclosing a part of the support structure, preferably a vertically running support pillar, and to cause lateral centering in two spatial directions for the submersible component via the closing movement of clamping jaws. Starting from this transverse centering, the submersible component can be moved vertically along the support structure using the crane system, until the gripping device is brought into the position provided for securing the turbine-generator unit.

For a preferred refinement, the transverse centering device can also be used for the precise vertical positioning of the submersible component. For this case, the enclosure element of the transverse centering device is adapted to a complementary attached counterpart on the support structure so that the closing movement assumes a desired vertical position through self-centering, for example, by the engagement of a conically running flange surface on the enclosure element in a corresponding complementary shaped groove on the support structure.

After the closing of the transverse centering device and the setting of the predetermined vertical position of the transverse centering device, the movable clamping elements of the gripping device are closed. If they are again attached in the form of pliers and given a rounded form, the final securing of the turbine-generator unit can be connected to vertical self centering in the case of encompassing the longitudinal axis of a barrel-shaped attached housing of a machine nacelle. The lifting of the turbine-generator unit out of the coupling device can then be performed by a lifting movement of the crane system. For this purpose, there is particularly preferably a multiple cable connection between the submersible component and the crane system.

For a preferred refinement of the invention, the submersible component is supplied to the underwater power plant along a guide cable. A guide cable pair running on both sides of the submersible component can preferably be used, whose length is set so that in the case of a movement of the submersible component along one guide cable, the lowering of the submersible component via the crane system is connected to a lateral movement in the direction toward the underwater power plant. For this purpose, one end of the guide cable is fastened on the support structure, while the other end runs over a hauling device, for example, a winch on board the water vehicle, in order to adapt the cable length. This length is set so that the section of the guide cable running in front of the submersible component up to the support structure has a desired inclination angle as a function of the ship position relative to the installation location of the underwater power plant and in relation to the submersion depth of the submersible component. A stop device can be attached in the guide cable, in order to bring the submersible component into a defined position upon the approach to the underwater power plant. Furthermore, after the coupling of the submersible component to the turbine-generator unit, the guide cable is tensioned and brought into a vertical position suitable for the lifting.

For an advantageous embodiment, the fastening of the guide cable on the support structure is permanently maintained, the unfastened end of the guide cable being guided away from the plant until winding in the turbine is reliably prevented during plant operation. For this purpose, the loose end of the guide cable can be stored on the ocean floor using a weight load. In addition, a buoyant device, which can be automatically triggered, can be connected to the free cable end. An embodiment is conceivable in which the weight ballast can be decoupled using a remote trigger and a buoyant volume attached at the cable end ensures the buoyancy up to the water surface, so that it is possible to haul in the cable without the use of a diver.

For an alternative embodiment of the submersible component of the lift device, the closing movement of the movable enclosure elements of the transverse centering device and the closing of the movable clamping elements of the gripping device occur from a position above the turbine-generator unit. For this purpose, the submersible component is again brought into the area of the underwater power plant, above the turbine-generator unit. The enclosure elements then encompass the support structure through a pivot movement originating from above and ensure at least the lateral centering of the submersible component.

For a refinement, the setting of the vertical distance to the turbine-generator unit can also be set by the closing of the enclosure element of the centering device. The gripping device then closes, the movable clamping elements having a pivot axis which is above the turbine-generator unit. Accordingly, for an advantageous embodiment, the gripping device encloses the housing of the machine nacelle from above. An advantage in relation the above-described gripping movement from below can be seen in that the guide of the supply cable leading downward from the machine nacelle cannot come into contact with the submersible unit. Therefore, no special protective measures for the electrical, hydraulic, and pneumatic connections leading away from the plant must be taken upon approach of the submersible component.

For an advantageous embodiment of the submersible component, the movable enclosure element of the transverse centering device is designed so that a funnel-shaped form results in the closed state of the enclosure element. This allows the transverse centering device to be used as a guide structure during an installation of the turbine-generator unit on the support structure. For this purpose, firstly the turbine-generator unit is lowered to rest on the submersible component, secured by the gripping device. The approach of the support structure occurs essentially vertically, at least one guide cable between the support structure and the water vehicle used for the installation and/or a crane system installed thereon again supporting the approach procedure. The transverse centering device interacts in the closed state with the upper part of the support structure directly above the support structure. In the course of the further lowering, the transverse centering device is guided over the upper part of the support structure and thus allows a first transverse orientation relative to the support structure. This procedure is supported by the funnel-shaped design of the closed enclosure element of the transverse centering device, which forms a conical inner surface.

In the further course of the lowering, the conically tapering coupling connecting piece of the turbine-generator unit comes into contact with the complementary shaped receptacle with the support structure, whereby the final centering of the turbine-generator unit relative to the support structure is performed and the coupling can be completed. The clamping element of the gripping device is subsequently opened and releases the turbine-generator unit. A lateral movement of the submersible component away from the support structure is made possible by opening the enclosure element of the transverse centering device, so that it can be safely removed from the underwater power plant.

The invention is explained in greater detail hereafter on the basis of preferred exemplary embodiments and in connection with illustrative figures. In the figures:

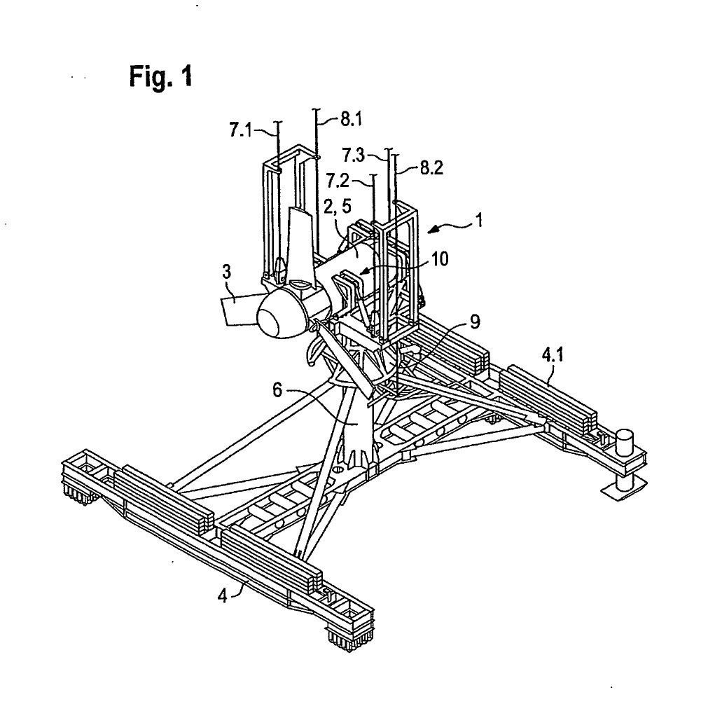

FIG. 1 shows an underwater power plant having the submersible component of a lifting device according to the invention in a perspective view.

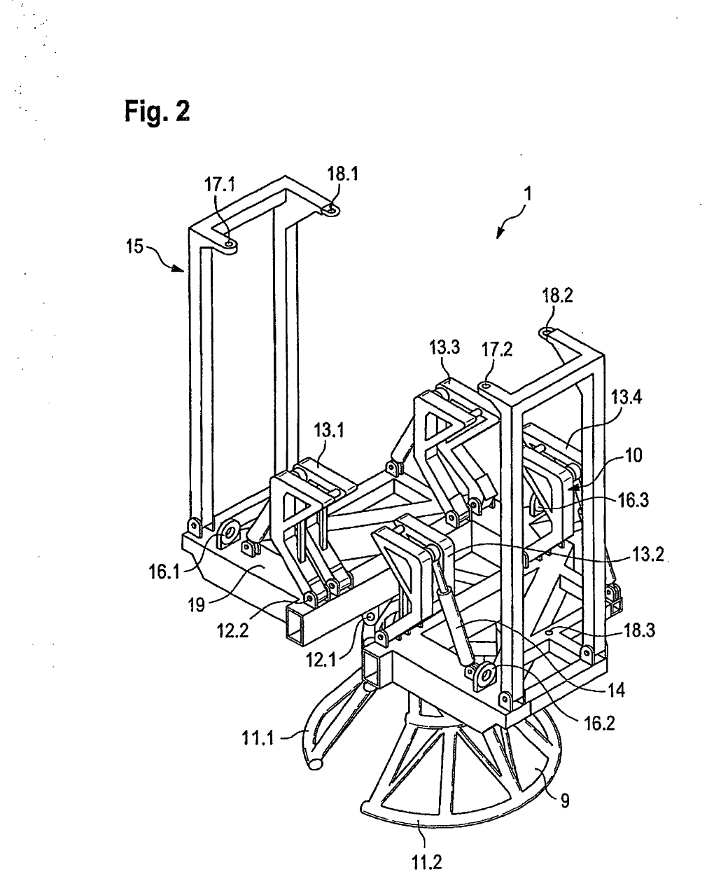

FIG. 2 shows a partial perspective view of the submersible component from FIG. 1.

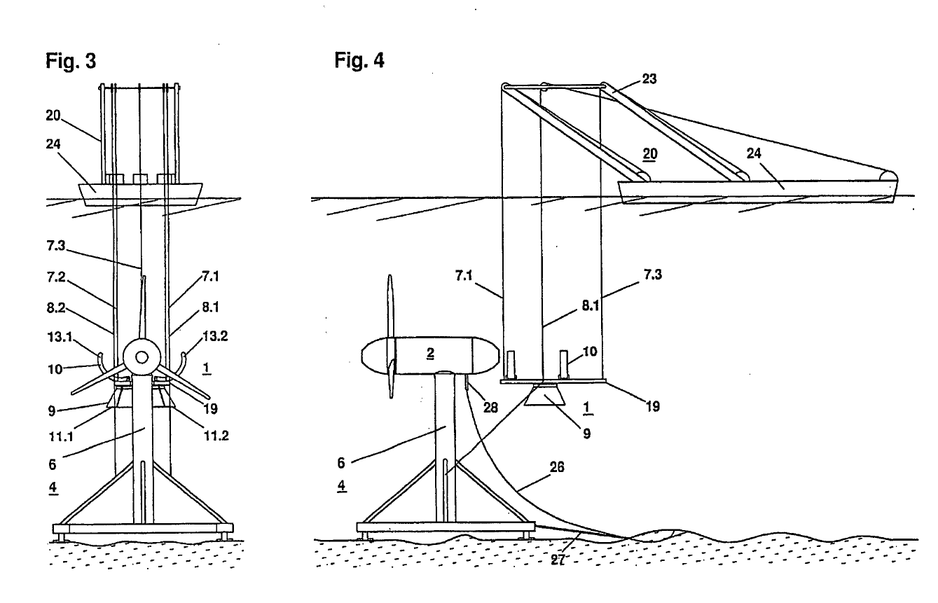

FIG. 3 shows a lifting device according to the invention in a front view during a lateral approach to an underwater power plant.

FIG. 4 shows a side view of FIG. 3.

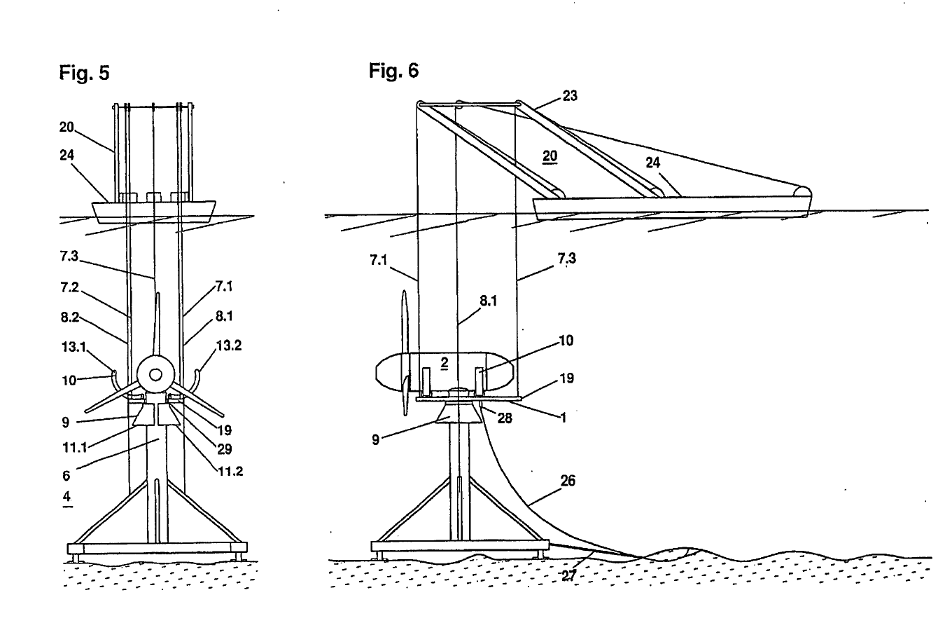

FIG. 5 shows a front view of the enclosure of a part of the support structure of the underwater power plant by the transverse centering device.

FIG. 6 shows a side view of FIG. 5.

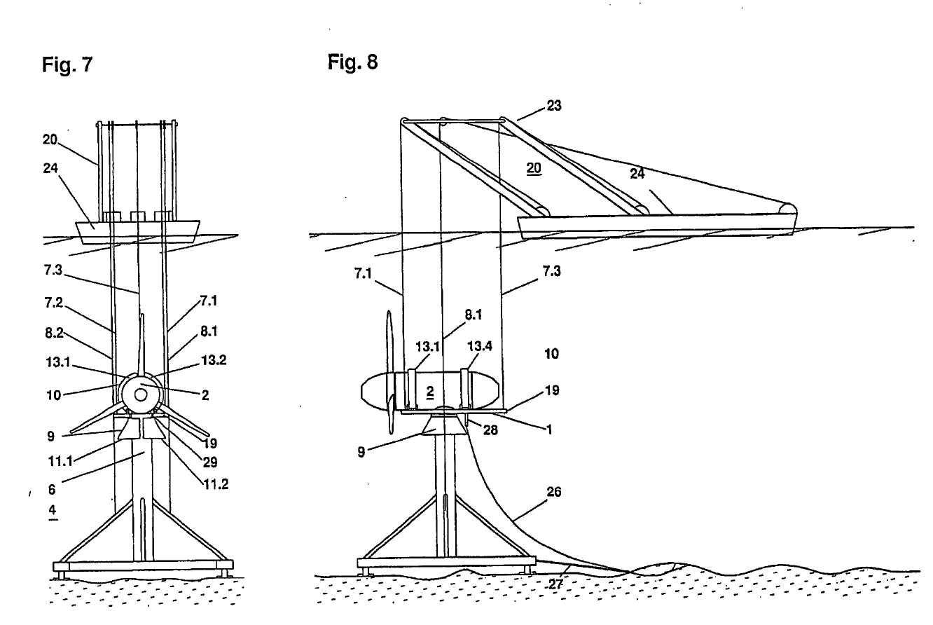

FIG. 7 shows a front view of a coupled-on transverse centering device and a coupled-on gripping device of the submersible component.

FIG. 8 shows a side view of FIG. 7.

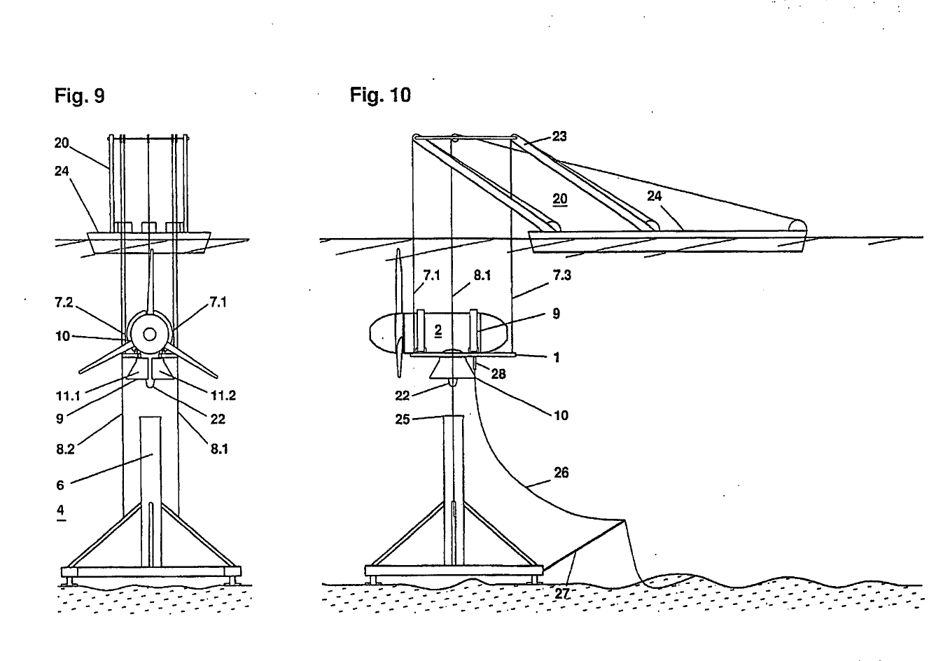

FIG. 9 shows the lifting of the turbine-generator unit by a lifting device according to the invention in a front view.

FIG. 10 shows a side view of FIG. 9.

An underwater power plant according to the species is sketched in FIG. 1. It comprises a turbine-generator unit 2 having a water turbine 3 and a machine nacelle 5. The turbine-generator unit 2 is placed on the support pillar 6 of a support structure 4, which is in turn supported via a ballasted foundation 4.1 against the floor of the body of water. Details of the detachable coupling between the turbine-generator unit 2 and the support pillar 6 of the support structure 4 are not obvious from the illustration of the figures. Implementing a coupling device having a conically tapering coupling connecting piece on the turbine-generator unit 2 and a complementary, conically tapering receptacle in the upper part of the support pillar 6 is conceivable. In the case of such a design, the turbine-generator unit can be lifted off of the support pillar 6 after unlocking of the coupling apparatus and/or, for the installation, the turbine-generator unit can be inserted from above into the coupling device on the support pillar 6.

The handling of the turbine-generator unit 2 is performed by a lifting device according to the invention. It comprises a submersible component 1, shown in FIGS. 1 and 2, which is lifted and lowered using a crane system (not shown in detail) via the support cables 7.1, 7.2, 7.3.

Possible crane systems on board a water vehicle include portal cranes or A-frame constructions. For a particularly advantageous embodiment, a double A-frame 23 coupled as a parallelogram is used, which, at low overall height, can lift the submersible component having a turbine-generator unit 2 located thereon on board a water vehicle 24. Such an embodiment is sketched in FIGS. 3 through 10. Furthermore, guide cables 8.1, 8.2 are shown in FIG. 1, which allow a vertical lowering movement of the submersible component 1 down into the area of the support pillar 6 in the present case.

Further details of the submersible component 1 are obvious from FIG. 2. As the basic component, it comprises a transverse centering device 9, which is formed in the present case from two movable enclosure elements 11.1, 11.2. These are connected so they are rotatable via a hinge 12.1 to the further parts of the submersible component 1 and allow an enclosure of the support structure, in the present case the vertically running support pillar 6, starting from a lateral approach of a submersible component 1 to an installed underwater power plant.

Because of the special shaping of the movable enclosure elements 11.1, 11.2 as parts of a funnel which is open to the rear, a capture device is provided for the case of a closed enclosure element 11.1, 11.2, which allows a first centering relative to the support pillar 6 of the support structure 4 upon lowering in the case of a vertical lowering of the submersible component 1 having a turbine-generator unit 2 located thereon. This case, which occurs during the plant installation, is shown in FIG. 1.

Furthermore, the submersible component 1 comprises a gripping device 10, which has the movable clamping elements 13.1, 13.2, 13.3, and 13.4 in the present case. They are each situated in pairs for the embodiment shown and form two closing mechanisms in the form of pliers, which positively enclose the machine nacelle 4 to secure and/or carry the turbine-generator unit 2. For this purpose, hydraulic cylinders 14 are provided in each case, which move the clamping elements 13.1-13.4 around an assigned hinge 12.2 in each case relative to a support frame 19 of the submersible component 1.

For the present embodiment, the submersible component 1 has a box-shaped attached cable guide 15. This allows guide cables 8.1, 8.2 to be led starting from the cable fastening points 16.1 and 16.2 through the bushes 17.1, 17.2, in order to thus reliably prevent winding around the water turbine 13. A guard against a lateral tilting movement is caused by situating the bushes 17.1, 17.2 above the center of gravity of the submersible component 1 having a turbine-generator unit located thereon. In addition, three support cables 7.1, 7.2, and 7.3 are used. Furthermore, for an advantageous embodiment, the possibility exists of opening the bushes 17.1, 17.2, in order to release the guide cables 8.1, 8.2 above the water surface. This allows the crane system used for lifting to be provided with a lesser lifting height. A winding guard is not required for the third cable fastening point 16.3 at the rear, which is located outside the circle of rotation of the water turbine 3.

Furthermore, the cable guide 15 is used for the sliding of the submersible component 1 along guide cables 8.1, 8.2. The guide openings 18.1 and 18.2 in the upper part of the cable guide 15 are used for this purpose. Further openings through which the guide cables 8.1, 8.2 are guided are provided in the lower area of the cable guide 15. One such opening is identified in the illustration of FIG. 2 by the reference numeral 18.3.

The mode of operation of the submersible component 1 is shown on the basis of front and side views in FIGS. 3-10. For the purpose of clarity, construction details of the cable guide 15 and hydraulic components for driving the transverse centering device 9 and the gripping device 10 are dispensed with in relation to the embodiments of the submersible component 1 shown in FIGS. 1 and 2. The approach of the submersible component 1 to an underwater power plant is shown in FIGS. 3 and 4. For this purpose, the water vehicle 24 having the crane system 20 is positioned on the rear side of the underwater power plant. Furthermore, the cable length of the guide cables 8.1, 8.2 is adapted relative to the issued length of the support cables 7.1, 7.2, and 7.3 in such a manner that an approach of the submersible component 1 occurs laterally and, for the final approach, the submersible component 1 is positioned somewhat below the turbine-generator unit 2 and to the rear thereof. In this position, a stop can be provided in the guide cable 8.1.

For the further approach, the water vehicle 24 and/or the crane system 20 are moved. For the further approach of the submersible component 1 to the support structure 4, in the embodiment shown, the support frame 20 is implemented as slotted over a part of the longitudinal extension, the support pillar 6 being inserted into the slot 29.

It is obvious from the front view of FIG. 3 that initially the transverse centering device 9 and the gripping device 10 of the submersible component 1 are open. Open enclosure elements 11.1, 11.2 of the transverse centering device 9 and open clamping elements 13.1, 13.2 of the gripping device 10 are outlined. In a next coupling step, which is shown in FIGS. 5 and 6 in front and side views, the gripping device 10 is closed by an inwardly directed movement of the enclosure elements 11.1, 11.2, which are implemented in the present case in the form of a two-part skirt. In this manner, at least partial enclosure of the support pillar 6 and therefore lateral centering of the submersible component 1 relative to the support structure 4 and thus to the turbine-generator unit 2 seated thereon is caused.

Various embodiments are conceivable for the transverse centering device 9. These may differ with respect to the number of the enclosure elements 11.1, 11.2 and the rotational axes assigned thereto. In particular, in addition to the movement shown in FIGS. 3-10 having a rotation around a vertical axis, a rotational movement around a transverse axis, in particular a folding movement from above, comes into consideration. For an alternative design, the transverse centering device 9 is implemented as passive and does not comprise any movable elements. The lateral centering can be caused by such a passive transverse centering device 9 as a U-shaped component, for example. Furthermore, it is conceivable to implement the transverse centering device 9 as skirt-shaped and to provide it with a lateral slot, whose transverse dimensions at the narrowest point allow the passage of the support pillar 6. Furthermore, embodiments of the transverse centering device 9 are conceivable which comprise multiple components interacting at various points with the support structure 4. These components may grasp diagonally running struts of the support structure 4, for example.

The further course of the coupling is shown in the front view of FIG. 7 and the side view of FIG. 8. For this purpose, the submersible component 1 was lifted vertically upward along the support pillar 6 using the crane system 20. The guide cables 8.1, 8.2 were previously tensioned and the installation ship 21 was moved over the support structure 4. After the submersible component 1 is lifted until the support frame 19 contacts the floor area of the turbine-generator unit 2, the gripping device 10 can close. Closed clamping elements 13.1, 13.2, and 13.4 are correspondingly obvious in FIGS. 7 and 8.

The submersible component 1 having the turbine-generator unit 2 secured thereon can subsequently be lifted. This is shown in the front view in FIG. 9 and the side view in FIG. 10. The lifting action is again executed using tensioned guide cables 8.1, 8.2, which run essentially vertically, in the case of which the conically tapering coupling connecting piece 22 is raised out of the receptacle 25 in the upper part of the support pillar 6.

Upon lifting of the turbine-generator unit 2, the connection cable 26 of the underwater power plant is carried along. A boom 27 is used for better control of this movement, which places the connection cable 26 at the rear of the water turbine 3 in a defined manner on the floor of the body of water upon renewed plant installation during lowering of the turbine-generator unit 2.

The procedure of lowering and inserting the conically tapering coupling connecting piece 22 into the receptacle 25 of the support pillar 6 can be derived from FIGS. 9 and 10 according to the above-described lifting procedure for the reinstallation of the turbine-generator unit 2.

An alternative embodiment of the submersible component 1 differs from the above-described embodiment in that the transverse centering device 9 and the gripping device 10 enclose the turbine-generator unit 2 through a clamp engagement from above. This is not shown in detail in the figures.

The invention can be implemented in various ways in the scope of the following claims. It is conceivable in particular to adapt the pivot direction of the transverse centering device and the gripping device of the submersible component to a specific plant type. Furthermore, the submersible component 1 can be equipped with various sensor systems, which measure and monitor the approach in relation to the support structure. In particular, optical systems or systems based on triangulation or even sonar come into consideration. In addition, the submersible component can be equipped with a separate underwater drive system acting in various spatial directions additionally or alternatively to a cable guide.

### LIST OF REFERENCE NUMERALS

1 submersible component
2 turbine-generator unit
3 water turbine
4 support structure
4.1 foundation
5 machine nacelle
6 support pillar
7.1, 7.2, 7.3 support cable
8.1, 8.2 guide cable
9 transverse centering device
10 gripping device
11.1, 11.2 enclosure element
12.1, 12.2 hinge
13.1, 13.2, 13.3, 13.4 clamping element
14 hydraulic cylinder
15 cable guide
16.1, 16.2, 16.3 cable fastening point
17.1, 17.2 bush
18.1, 18.2, 18.3 guide opening
19 support frame
20 crane system
21 installation ship
22 conically tapering coupling connecting piece
23 double A-frame
24 water vehicle
25 receptacle
26 connection cable
27 boom
28 cable guard
29 slot

1-15. (canceled)

16. A lifting device for placing and/or for lifting a turbine-generator unit of an underwater power plant onto or off of a support structure, comprising:
a submersible component having a transverse centering device and a gripping device;
wherein the transverse centering device causes lateral centering of the submersible component relative to the turbine-generator unit by a support on the support structure; and
the gripping device comprises a movable clamping element for the detachable securing of the turbine-generator unit.

17. The lifting device according to claim 1, characterized in that the transverse centering device comprises a movable enclosure element, which is designed to encompass a part of the support structure.

18. The lifting device according to claim 17, characterized in that the enclosure element comprises two clamping jaws.

19. The lifting device according to claim 17, characterized in that the enclosure element of the transverse centering device forms a centering cone in the closed state, which is guided over the upper end of the support structure during the placement of the turbine-generator unit and releases the support structure by an opening movement of the enclosure element after the detachment of the securing of the turbine-generator unit.

20. The lifting device according to claim 16, characterized in that the turbine-generator unit comprises a machine nacelle and the clamping element secures the turbine-generator unit by at least partially encompassing the housing of the machine nacelle.

21. The lifting device according to claim 20, characterized in that the clamping element encompasses the machine nacelle from above.

22. The lifting device according to claim 20, characterized in that the clamping element encompasses the machine nacelle from below.

23. The lifting device according to claim 16, characterized in that a crane system of a water vehicle is assigned to the submersible component and the submersible component carries the turbine-generator unit during the placement and/or the lifting.

24. The lifting device according to claim 23, characterized in that the gripping device carries the turbine-generator unit.

25. A method for lifting a turbine-generator unit of an underwater power plant, which rests on a support structure, having the following method steps:
a submersible component having a transverse centering device and a gripping device is positioned using a crane system in relation to the underwater power plant so that the transverse centering device causes lateral centering of the submersible component relative to the turbine-generator unit by a support on the support structure;
after the lateral centering, the gripping device secures the turbine-generator unit using a movable clamping element; and
the crane system subsequently lifts the submersible component with the secured turbine-generator unit out of the support structure.

26. The method according to claim 25, characterized in that the lateral centering is performed using a movable enclosure element, which encompasses a part of the support structure.

27. The method according to claim 26, characterized in that the submersible component approaches the underwater power plant from the side and the movable enclosure element of the transverse centering device encloses a part of the support structure from the side and subsequently the clamping element of the gripping device secures the housing of the machine nacelle of the turbine-generator unit of the underwater power plant by an enclosure movement from below.

28. The method according to claim 26, characterized in that the submersible component approaches the underwater power plant from above and the movable enclosure element of the transverse centering device encloses a part of the support structure through a movement from above and the movable clamping element secures the housing of a machine nacelle of the turbine-generator unit of the underwater power plant through an encompassing movement originating from above.

29. The method according to claim 25 characterized in that the submersible component approaches the underwater power plant along a guide cable.

30. The method according to claim 26 characterized in that the submersible component approaches the underwater power plant along a guide cable.

31. The method according to claim 27 characterized in that the submersible component approaches the underwater power plant along a guide cable.

32. The method according to claim 28 characterized in that the submersible component approaches the underwater power plant along a guide cable.

33. The method according to claim 29, characterized in that one end of the guide cable is permanently connected to the support structure and the other end can be raised as needed from a storage location on the ocean floor via a remote-controllable buoyancy system to the ocean surface.

34. The method according to claim 30, characterized in that one end of the guide cable is permanently connected to the support structure and the other end can be raised as needed from a storage location on the ocean floor via a remote-controllable buoyancy system to the ocean surface.

35. The method according to claim 31, characterized in that one end of the guide cable is permanently connected to the support structure and the other end can be raised as needed from a storage location on the ocean floor via a remote-controllable buoyancy system to the ocean surface.
